(19) United States
(12) Patent Application Publication
(10) Pub. No.: US 2025/0279693 A1
(43) Pub. Date: Sep. 4, 2025

(54) MOTOR

(71) Applicant: MITSUBA Corporation, Gunma (JP)

(72) Inventors: SATOSHI NAGAMOTO, Gunma (JP); HIROSHI UEHARA, Gunma (JP)

(73) Assignee: MITSUBA Corporation, Gunma (JP)

(21) Appl. No.: 19/053,341

(22) Filed: Feb. 13, 2025

(30) Foreign Application Priority Data
Feb. 29, 2024 (JP) 2024-030288

(51) Int. Cl. H02K 5/22

(52) U.S. Cl. CPC H02K 5/225

(57) ABSTRACT

A motor includes: a terminal, including a slit where a winding drawn out from a coil is crimped; and a terminal holder, holding the terminal. The terminal holder includes: an accommodation groove, formed between a first sidewall and a second sidewall arranged at predetermined intervals in a width direction orthogonal to an extension direction of the winding, and accommodating the winding; a rib, provided on a portion of the first sidewall in the extension direction, and reducing a width dimension of the accommodation groove; and a locking protrusion, provided on the second sidewall side at a position offset in the extension direction from the rib, and locking the winding accommodated in the accommodation groove.

### CROSS-REFERENCE TO RELATED APPLICATION

This application claims the priority benefit of Japan application serial no. 2024-030288, filed on Feb. 29, 2024. The entirety of the above-mentioned patent application is hereby incorporated by reference herein and made a part of this specification.

### BACKGROUND

### Technical Field

The disclosure relates to a motor.

### Related Art

In recent years, efforts have been made to promote the Sustainable Development Goals (hereinafter “SDGs”, the 2030 Agenda for Sustainable Development, adopted at the UN Summit on Sep. 25, 2015). Accordingly, technologies aimed at reducing waste or defective products are known to ensure sustainable production and consumption patterns.

Conventionally, there has been known a motor which includes: a terminal, in which a lead part of a winding drawn out from a stator coil is crimped, in order to connect the lead part to a substrate; and a terminal holder, holding the terminal. For example, in the motor described in WO 2022/102440, the terminal includes multiple slits in which the lead part is crimped. In the terminal holder, multiple guide grooves (accommodation grooves) are formed to guide the lead part. In a state in which the lead part is temporarily held in each of the multiple guide grooves, the lead part is crimped in the slit of the terminal and the terminal is held by the terminal holder.

In the guide groove of the terminal holder, a rib is formed on both sides or on one side to temporarily hold the lead part. The lead part is temporarily held in the guide groove by being press-fitted between the ribs, or between a side surface of the guide groove and the rib.

However, in the motor described above, when the lead part is temporarily held in multiple guide grooves, the lead part must have a press-fit load applied thereto and be inserted into the guide groove. Since the winding is wound on a stator core and formed into a coil while tension is applied thereto by a winding machine, a wire diameter is changed according to the tension applied when the coil is formed. Accordingly, a load required for press-fitting and a push-in amount of the lead part of the winding are changed according to the wire diameter. It is preferable to press-fit the lead part into the guide groove automatically by a machine such as a forming machine. However, in the case where the press-fit load by the machine or the push-in amount is insufficient, manual work by an operator becomes necessary, which is not efficient.

In the case of attempting to temporarily hold multiple lead parts simultaneously on a single terminal holder, the guide groove may be deformed due to press-fitting of the lead part. In the case where the lead part is press-fitted and a guide groove is increased in width, the guide groove adjacent thereto may be decreased in width. Hence, it may become difficult for the machine to insert the lead part into the guide groove, and it may become necessary to redo the work.

### SUMMARY

A motor of the disclosure includes: a terminal, including a slit where a winding drawn out from a coil is crimped; and a terminal holder, holding the terminal. The terminal holder includes: an accommodation groove, formed between a first sidewall and a second sidewall arranged at predetermined intervals in a width direction orthogonal to an extension direction of the winding, and accommodating the winding; a rib, provided on a portion of the first sidewall in the extension direction, and reducing a width dimension of the accommodation groove; and a locking protrusion, provided on the second sidewall side at a position offset in the extension direction from the rib, and locking the winding accommodated in the accommodation groove.

### BRIEF DESCRIPTION OF THE DRAWINGS

FIG. 1 is a longitudinal cross-sectional view of a motor according to an embodiment.

FIG. 2 is a perspective view of a front surface side showing a configuration of the motor with a rotor removed.

FIG. 3 is a perspective view of a back surface side showing a configuration of the motor with a driver case and the rotor removed.

FIG. 4 is an exploded perspective view of the motor.

FIG. 5 is a perspective view of an area around a terminal and a terminal holder.

FIG. 6 is a perspective view of the terminal.

FIG. 7 is a perspective view showing a state before a lead part of a coil is inserted into an accommodation groove of the terminal holder.

FIG. 8 is an enlarged explanatory diagram of an area around the accommodation groove.

FIG. 9 is an explanatory diagram showing a dimensional relationship between the accommodation groove, a rib, and a locking protrusion.

FIG. 10A and FIG. 10B include explanatory diagrams of a state (FIG. 10A) before the lead part of the coil is inserted into the accommodation groove of the terminal holder and a state (FIG. 10B) after insertion, as viewed from a longitudinal direction of the accommodation groove.

FIG. 11A and FIG. 11B include explanatory diagrams of a state (FIG. 11A) before the lead part of the coil is inserted into the accommodation groove of the terminal holder and a state (FIG. 11B) after insertion, as viewed from a depth direction of the accommodation groove.

FIG. 12A and FIG. 12B include explanatory diagrams of a state (FIG. 12A) before the terminal is crimped to the lead part and a state (FIG. 12B) after crimping, as viewed from the longitudinal direction of the accommodation groove.

### DESCRIPTION OF THE EMBODIMENTS

The disclosure provides a motor in which temporary holding of a winding can be made easy and work efficiency can be improved.

According to the disclosure, it is possible to easily temporarily hold the lead part and improve work efficiency and yield rate.

The following describes, as one aspect of a motor according to an embodiment of the disclosure, a motor which is, for example, mounted in a vehicle such as an automobile and drives a power slide door, a fan device, an electric hydraulic pump, or the like.

### [Overall Configuration of Motor 2]

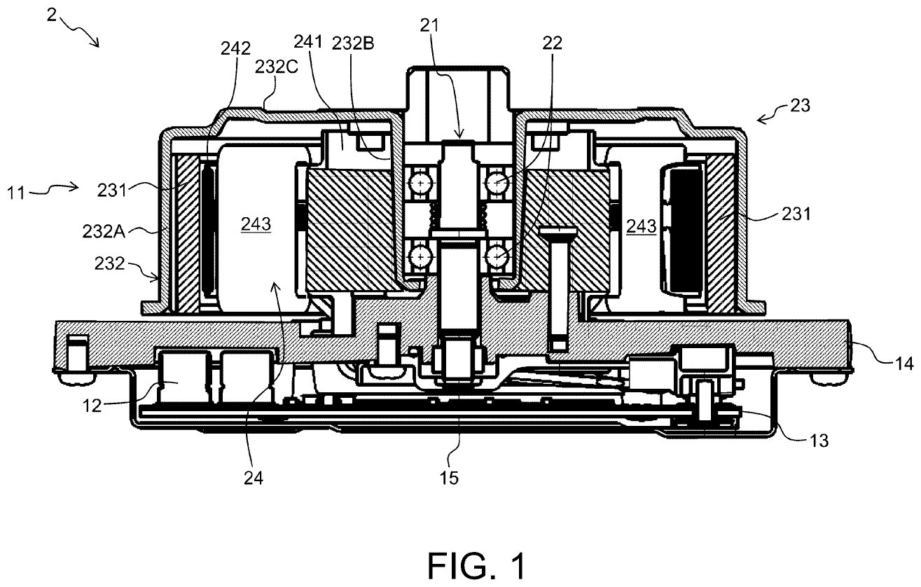

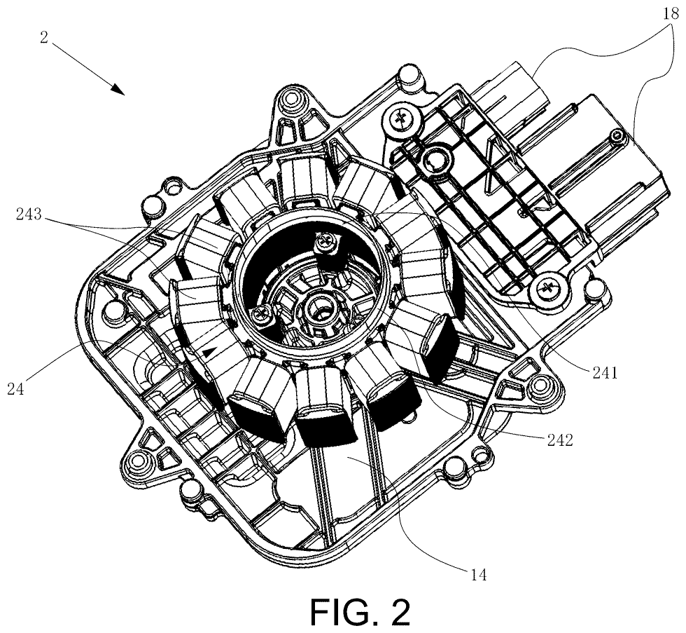

A configuration of the motor 2 will be described with reference to FIG. 1 and FIG. 2. FIG. 1 is a longitudinal sectional view of the motor 2. FIG. 2 is a perspective view of a front surface side showing the configuration of the motor 2 with the rotor 23 removed.

As shown in FIG. 1 and FIG. 2, the motor 2 is a so-called “integrated electromechanical type” electric motor that includes a brushless motor 11 of an outer rotor type and a substrate 13 on which a driver circuit 12 is mounted.

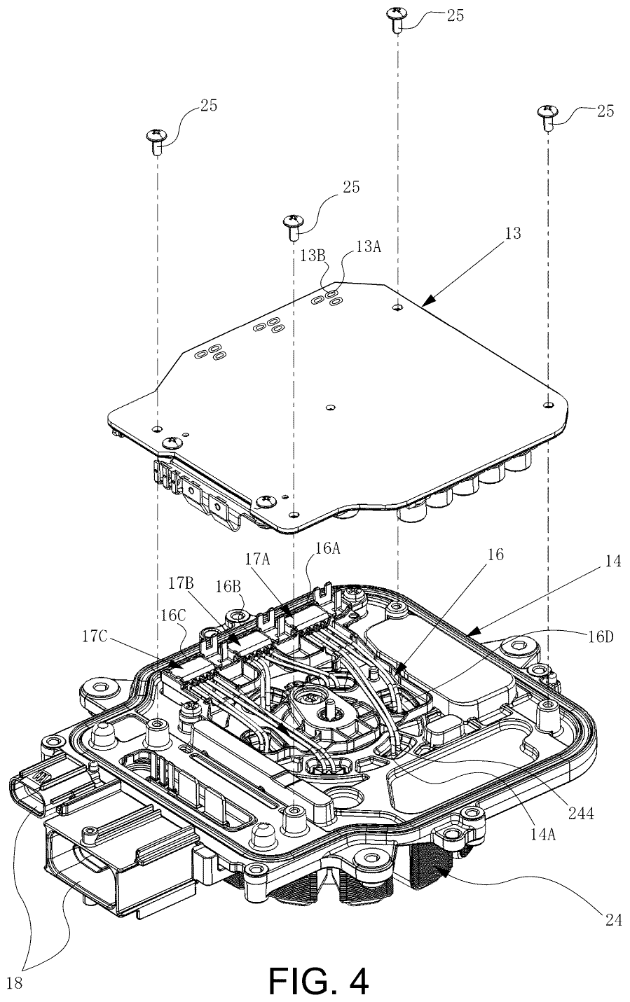

The motor 2 includes, in addition to the brushless motor 11, the driver circuit 12, and the substrate 13, a motor bracket 14, a driver case 15, a terminal holder 16 (see FIG. 4), terminals 17A to 17C (see FIG. 4), and a connector unit 18.

The brushless motor 11 is supported by the motor bracket 14. The brushless motor 11 is arranged on one side (front surface side) in a thickness direction of the motor bracket 14. The driver case 15 is fastened to the other side (back surface side) in the thickness direction of the motor bracket 14 by multiple screws.

The connector unit 18 formed by integrating two connectors to which an external harness is connected is attached to an end of the motor bracket 14. The brushless motor 11, the driver circuit 12, and the connector unit 18 are electrically connected.

As shown in FIG. 1, the brushless motor 11 includes a shaft 21, multiple bearings 22 provided on an outer periphery of the shaft 21, a rotor 23 rotatably supported around an axis of the shaft 21 via the bearing 22, and a stator 24 of an annular shape fixed with a predetermined interval in a radial direction from the rotor 23.

The shaft 21 is a fixing shaft fixed to the front surface side of the motor bracket 14. In the following description related to the components of the motor 2, an axial direction of the shaft 21 is simply referred to as the “axial direction”, a radial direction centered on the axis of the shaft 21 is simply referred to as the “radial direction”, and a circumferential direction centered on the axis of the shaft 21 is simply referred to as the “circumferential direction”.

The rotor 23 includes multiple permanent magnets 231 arranged at equal intervals in the circumferential direction to surround an outer periphery of the stator 24, and a rotor yoke 232 that supports the multiple permanent magnets 231 and is rotatably supported on the shaft 21.

The rotor yoke 232 is arranged on the front surface side of the motor bracket 14 to be concentric with the axis of the shaft 21. The rotor yoke 232 is rotatably supported on the shaft 21 via multiple bearings 22. Furthermore, the rotor yoke 232 includes an outer peripheral wall 232A, an inner peripheral wall 232B, and a connecting wall 232C.

The outer peripheral wall 232A presents a cylindrical outer shape. The outer peripheral wall 232A is arranged radially outside of the stator 24. Furthermore, the outer peripheral wall 232A supports the multiple permanent magnets 231 on its inner peripheral surface. In other words, the multiple permanent magnets 231 are fixed to the inner peripheral surface of the outer peripheral wall 232A at predetermined intervals in the circumferential direction.

The inner peripheral wall 232B presents a cylindrical outer shape. The inner peripheral wall 232B is arranged radially inside of the stator 24. Furthermore, the inner peripheral wall 232B is rotatably supported on the shaft 21 via multiple bearings 22.

The connecting wall 232C presents a disk-like outer shape. The connecting wall 232C connects one axial end of the outer peripheral wall 232A and one axial end of the inner peripheral wall 232B. Furthermore, the connecting wall 232C is arranged on a side opposite to the motor bracket 14 with the stator 24 therebetween. The connecting wall 232C is arranged to face and be spaced by a predetermined interval in the axial direction from the stator 24.

### [Configuration of Stator 24]

The stator 24 is accommodated in a space surrounded by the outer peripheral wall 232A, the inner peripheral wall 232B, the connecting wall 232C, and a front surface of the motor bracket 14. The stator 24 is fixed on the front surface side of the motor bracket 14, radially inside of the multiple permanent magnets 231. Furthermore, the stator 24 faces and is spaced by a predetermined gap in the radial direction from the multiple permanent magnets 231.

As shown in FIG. 2, the stator 24 includes a stator core 241 of a cylindrical shape, an insulating stator insulator 242 mounted on both axial sides of multiple teeth protruding radially outward from the stator core 241, and a coil 243 in which a winding is wound on the stator insulator 242. The coil 243 is a conductive winding, and is, for example, formed from a copper wire.

The stator 24 generates a magnetic field by a current flowing through the coil 243. By attraction force and repulsion force generated between the magnetic field generated by the coil 243 and the multiple permanent magnets 231, the rotor yoke 232 is rotated about the axis of the shaft 21.

The driver circuit 12 controls the generation of magnetic fields by multiple coils 243. The driver circuit 12 is composed of multiple electronic parts (for example, transistors, diodes, and resistors) surface-mounted on a front surface of the substrate 13 facing the motor bracket 14. The electronic parts constituting the driver circuit 12 are not arranged on a back surface side of the substrate 13 facing the driver case 15.

### [Configuration of Motor Bracket 14]

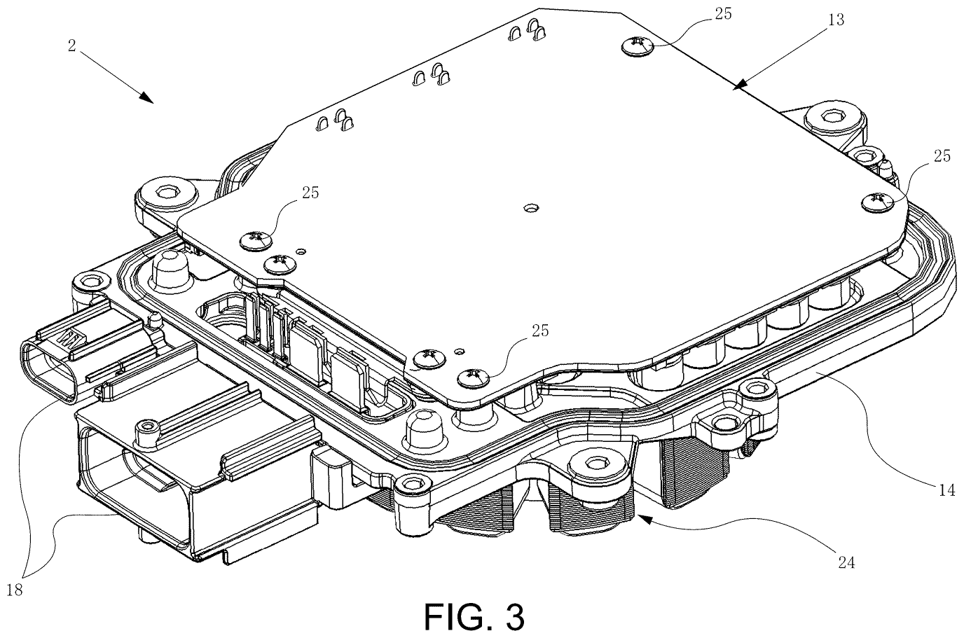

FIG. 3 is a perspective view of a back surface side showing a configuration of the motor 2 with the driver case 15 and the rotor 23 removed. FIG. 4 is an exploded perspective view of component parts arranged on the back surface side of the motor bracket 14.

As shown in FIG. 3 and FIG. 4, the substrate 13 is fastened to the motor bracket 14 by multiple screws 25. On the back surface side (side facing the substrate 13) of the motor bracket 14, the terminal holder 16 is provided. The motor bracket 14 includes an opening 14A. The opening 14A penetrates from the front surface side to the back surface side of the motor bracket 14, allowing a lead part 244 of the winding forming the coil 243 to be drawn out to the back surface side of the motor bracket 14. The lead part 244 has elastic force and is elastically deformed when inserted into an accommodation groove 36 to be described later.

### [Configuration of Terminals 17A to 17C]

The terminals 17A to 17C electrically connect the driver circuit 12 and the coil 243. The brushless motor 11 includes the three terminals 17A to 17C in order to supply three-phase (U-phase, V-phase, and W-phase) power to multiple coils 243. That is, the brushless motor 11 is a three-phase AC motor. In the present embodiment, the brushless motor 11 includes a total of 12 coils 243, with 4 coils for each phase.

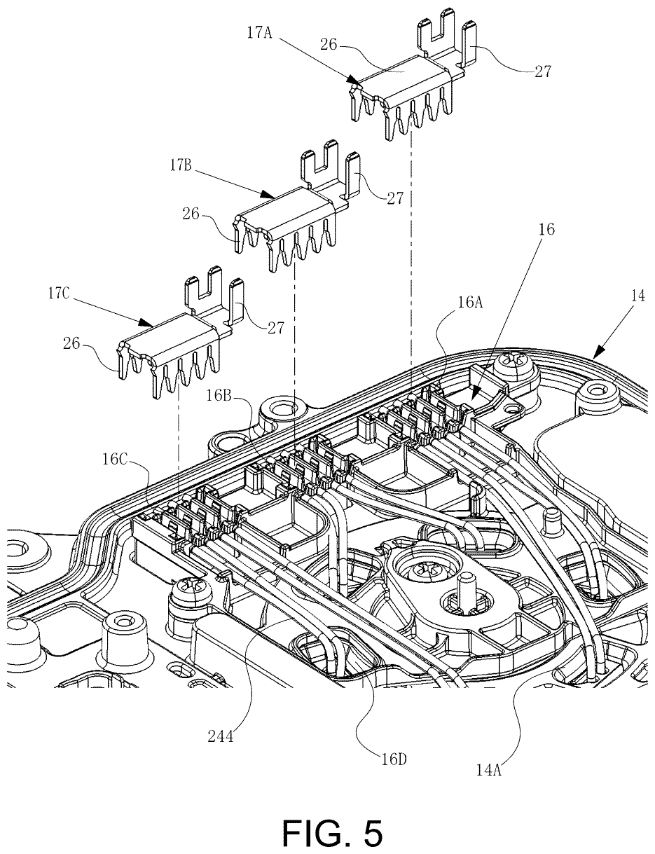

As shown in FIG. 5, the terminals 17A to 17C are made of conductive metal and are integrally formed with a main body 26 and a terminal part 27. The terminals 17A to 17C are held by holding parts 16A to 16C of the terminal holder 16.

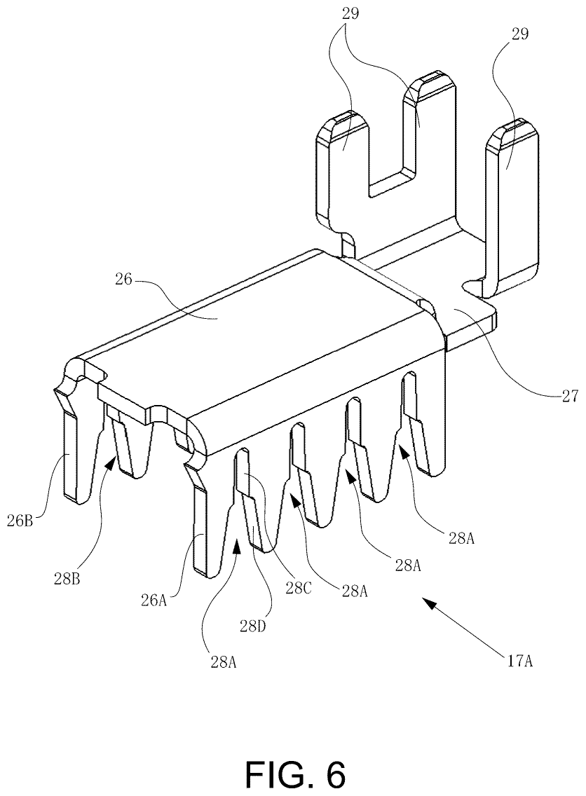

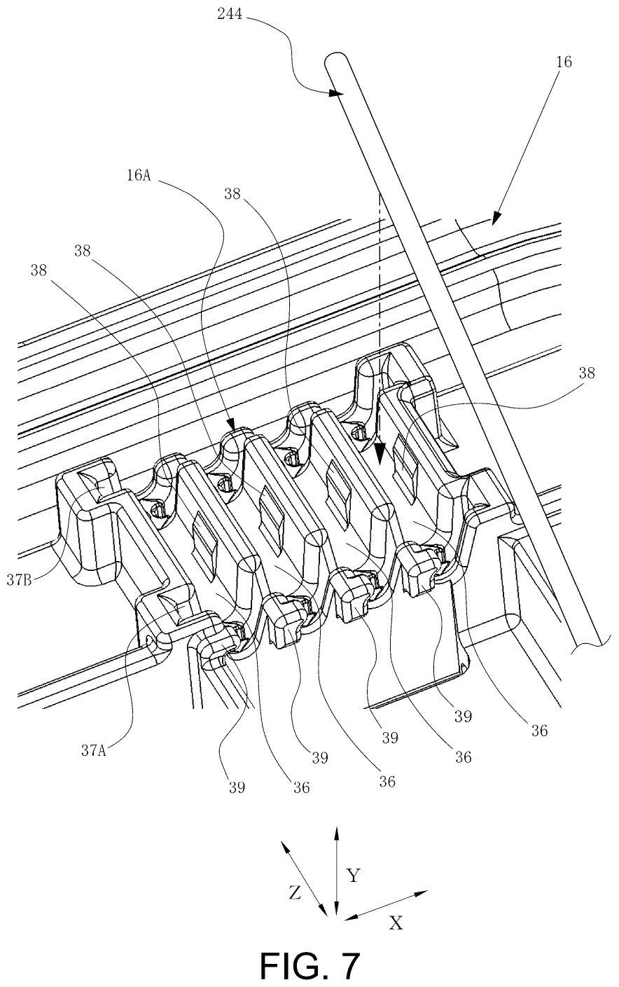

As shown in FIG. 6, the main body 26 is formed to have a substantially horizontal U-shape in cross-section and includes two fitting pieces 26A and 26B. The fitting pieces 26A and 26B are fitted with fitting grooves 37A and 37B (see FIG. 7) of the terminal holder 16 to be described later. The fitting piece 26A and the fitting piece 26B are arranged parallel to each other. FIG. 6 illustrates a configuration of the terminal 17A, and the terminals 17B and 17C have the same configuration as the terminal 17A.

The fitting piece 26A and the fitting piece 26B respectively include four slits 28A and four slits 28B. In the slits 28A and 28B, the lead part 244 of the winding drawn out from the coil 243 is crimped. The slits 28A and 28B each include a crimping part 28C where the lead part 244 is crimped, and a tapered part 28D that widens in width from the crimping part 28C toward a tip in a crimping direction. The crimping part 28C has a width smaller than a wire diameter of the lead part 244. The tapered part 28D has a width larger than the wire diameter of the lead part 244 and is formed in a shape to guide the lead part 244 into the crimping part 28C.

The terminal part 27 includes multiple connection pieces 29 and is electrically connected to the driver circuit 12. The substrate 13 includes a through hole 13A (see FIG. 4) and a land 13B (see FIG. 4). The through hole 13A penetrates from the front surface (mounting surface) to the back surface of the substrate 13. The land 13B is a conductive film continuously formed from an inner wall surface of the through hole 13A to around the through hole 13A, and is connected to a pattern of an output terminal for each phase in the driver circuit 12. The land 13B is soldered by the connection piece 29 inserted into the through hole 13A. Accordingly, the terminals 17A to 17C are connected to the output terminals for each phase in the driver circuit 12.

### [Configuration of Terminal Holder 16]

As shown in FIG. 5, the terminal holder 16 includes the holding parts 16A to 16C and an opening 16D. The terminal holder 16 is made of an insulating material (for example, resin). The holding parts 16A to 16C hold the terminals 17A to 17C respectively, and also hold the lead part 244 of the winding crimped in the slits 28A and 28B of the terminals 17A to 17C. The opening 16D penetrates from a front surface side to a back surface side of the terminal holder 16, allowing the lead part 244 of the winding forming the coil 243 to be drawn out to the back surface side of the terminal holder 16.

As shown in FIG. 7, in the holding part 16A, multiple accommodation grooves 36, the fitting grooves 37A and 37B, multiple ribs 38, and multiple locking protrusions 39 are formed. The accommodation groove 36 accommodates the lead part 244 of the winding drawn out from the coil 243. In the present embodiment, the holding part 16A includes four each of the accommodation grooves 36, multiple ribs 38, and locking protrusions 39, and holds four lead parts 244. The disclosure is not limited thereto, and the number of lead parts 244 held by one holding part can be appropriately changed according to the number of coils 243 and the number of phases of power supplied to the coil 243. Accordingly, the number of accommodation grooves 36, multiple ribs 38, locking protrusions 39, and slits in the terminals 17A to 17C can also be changed.

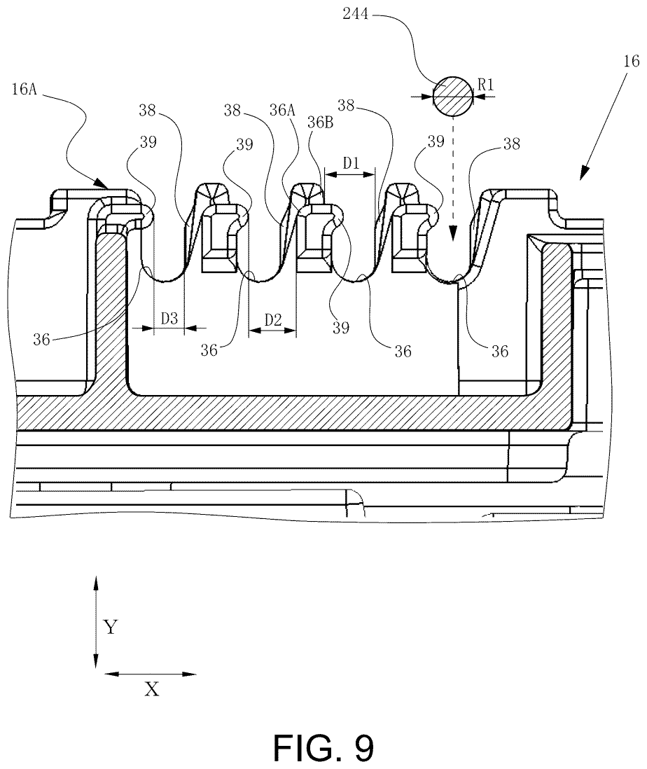

FIG. 7 illustrates only the configuration of the holding part 16A, and the holding parts 16B and 16C have similar configurations. In FIG. 7 and FIG. 9, only one lead part 244 is illustrated. However, in an actual process, it is preferable to simultaneously insert multiple lead parts 244 into multiple accommodation grooves 36. The accommodation groove 36 is an elongated groove whose longitudinal direction is an extension direction Z of the lead part 244 accommodated therein. Hereinafter, the extension direction of the lead part 244 accommodated in the accommodation groove 36 is simply referred to as the “extension direction”, a width direction of the accommodation groove 36 orthogonal to the extension direction is simply referred to as the “width direction”, and a depth direction of the accommodation groove 36 orthogonal to both the extension direction and the width direction is simply referred to as the “depth direction”. The four accommodation grooves 36 are arranged in parallel with respect to the width direction X.

The fitting grooves 37A and 37B are arranged in positions intersecting the extension direction Z of the accommodation groove 36 and are formed along the width direction X. In the present embodiment, the fitting grooves 37A and 37B are arranged near both ends of the accommodation groove 36.

The fitting grooves 37A and 37B are formed with dimensions in the width direction X that match the dimensions of the fitting pieces 26A and 26B of the terminal 17A. Accordingly, when the lead part 244 is crimped into the slits 28A and 28B, since the fitting pieces 26A and 26B are simultaneously fitted with the fitting grooves 37A and 37B, the terminal 17A can be held by the holding part 16A.

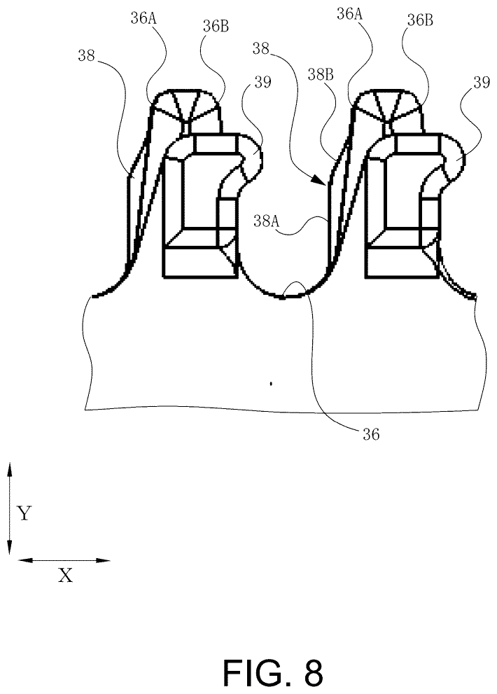

As shown in FIG. 8, the accommodation groove 36 is formed between a first sidewall 36A and a second sidewall 36B that are arranged at predetermined intervals in the width direction X. The accommodation groove 36 is a groove having a substantially V-shape in cross-section, having a large width on an upper surface (open end) side and a small width on a bottom surface side.

Each rib 38 is arranged inside the accommodation groove 36. The rib 38 is provided on a portion of the first sidewall 36A in the extension direction Z. Furthermore, the rib 38 protrudes in the width direction X from the first sidewall 36A toward the second sidewall 36B. That is, the rib 38 reduces the dimension of the accommodation groove 36 in the width direction X at a portion in the extension direction Z.

The locking protrusion 39 is provided on the second sidewall 36B side at a position offset in the extension direction Z from the rib 38. The locking protrusion 39 protrudes in a direction (namely, from the second sidewall 36B side toward the first sidewall 36A side; width direction X) opposite to a direction in which the rib 38 protrudes. Furthermore, in the depth direction Y, the locking protrusion 39 is separated from the bottom surface of the accommodation groove 36. In other words, a space accommodating the lead part 244 of the winding is formed between the bottom surface of the accommodation groove 36 and the locking protrusion 39. Accordingly, the locking protrusion 39 locks the lead part 244 of the winding accommodated in the accommodation groove 36.

The lead part 244 accommodated inside the accommodation groove 36 is guided by the rib 38 to the side where the locking protrusion 39 is located. Furthermore, the locking protrusion 39 locks and restricts the lead part 244 from detaching from the accommodation groove 36. Hence, the lead part 244 is temporarily held inside the accommodation groove 36. Temporary holding refers to a state in which, while the lead part 244 is not fixed to the accommodation groove 36, the lead part 244 does not detach from the accommodation groove 36.

As described later, when the lead part 244 is inserted into the accommodation groove 36, the locking protrusion 39 always comes into contact with the lead part 244. However, since the locking protrusion 39 has a tip formed in a curved surface shape, damage can be prevented from being caused to the lead part 244. The locking protrusion 39 has rigidity and is not elastically deformed when locking the lead part 244.

As shown in FIG. 9, in the width direction X, an interval D1 between the rib 38 and the second sidewall 36B facing the rib 38 is larger than a wire diameter R1 of the lead part 244. In the width direction X, an interval D2 between the locking protrusion 39 and the first sidewall 36A facing the locking protrusion 39 is larger than the wire diameter R1 of the lead part 244. In the width direction X, an interval D3 between a tip of the rib 38 and the tip of the locking protrusion 39 is smaller than the wire diameter R1 of the lead part 244.

In the depth direction Y, the rib 38 is located closer to the bottom surface side of the accommodation groove 36 than the locking protrusion 39. Being located on the bottom surface side here means that at least a portion of the rib 38 is located closer to the bottom surface side of the accommodation groove 36 than the locking protrusion 39 in the depth direction Y. Accordingly, in the case where the lead part 244 is inserted into the accommodation groove 36, since the lead part 244 is guided by the rib 38 to the side where the locking protrusion 39 is located and to the lower side (bottom surface side) of the locking protrusion 39, the lead part 244 is reliably temporarily held inside the accommodation groove 36.

The rib 38 includes a flat surface 38A and an inclined surface 38B. The flat surface 38A is located on the bottom surface side of the accommodation groove 36 and is the most protruding surface of the rib 38 in the width direction X. The inclined surface 38B is inclined from the first sidewall 36A toward the direction in which the rib 38 protrudes. Accordingly, in the case where the lead part 244 is accommodated inside the accommodation groove 36, the lead part 244 is guided to the locking protrusion 39 side by the inclined surface 38B. Hence, the lead part 244 is further reliably temporarily held inside the accommodation groove 36.

### [Assembly Process of Motor 2]

Next, a process for assembling the substrate 13, motor bracket 14, terminal holder 16, and terminals 17A to 17C will be described. In the following description, a process in which the terminal 17A and the lead part 244 are held by the holding part 16A of the terminal holder 16 will be mainly described. However, a process for holding the terminals 17B, 17C and the lead part 244 by the holding parts 16B and 16C is performed in the same manner, and a description thereof will thus be omitted.

First, the terminal holder 16 is attached to the back surface of the motor bracket 14. The terminal holder 16 is fastened to the motor bracket 14 by multiple screws. During the process for attaching the terminal holder 16 to the motor bracket 14, the lead part 244 of the winding forming the coil 243 is drawn out to the back surface side of the terminal holder 16 through the openings 14A and 16D (see FIG. 4 and FIG. 5).

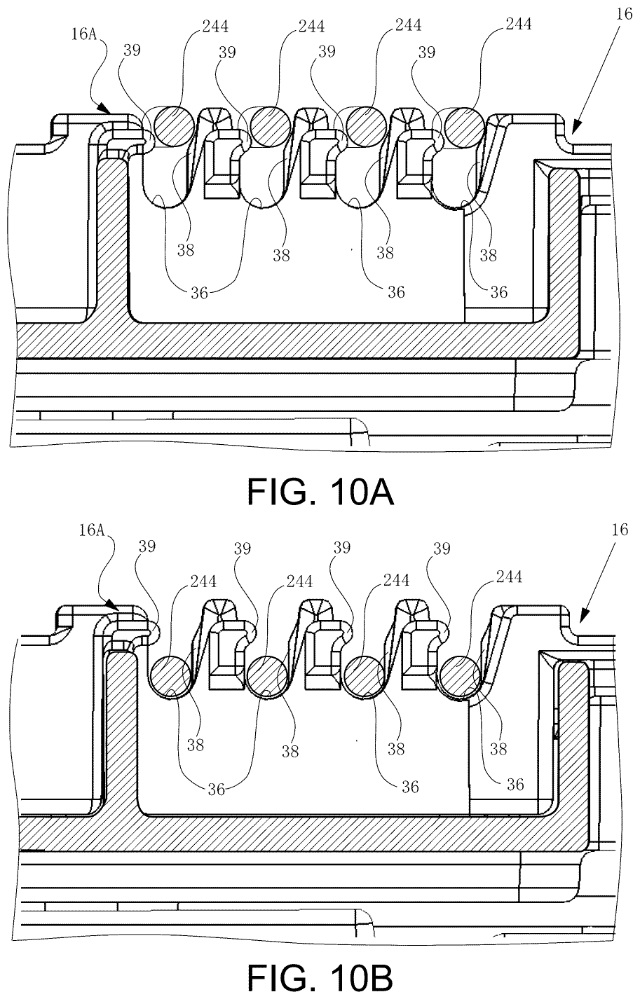

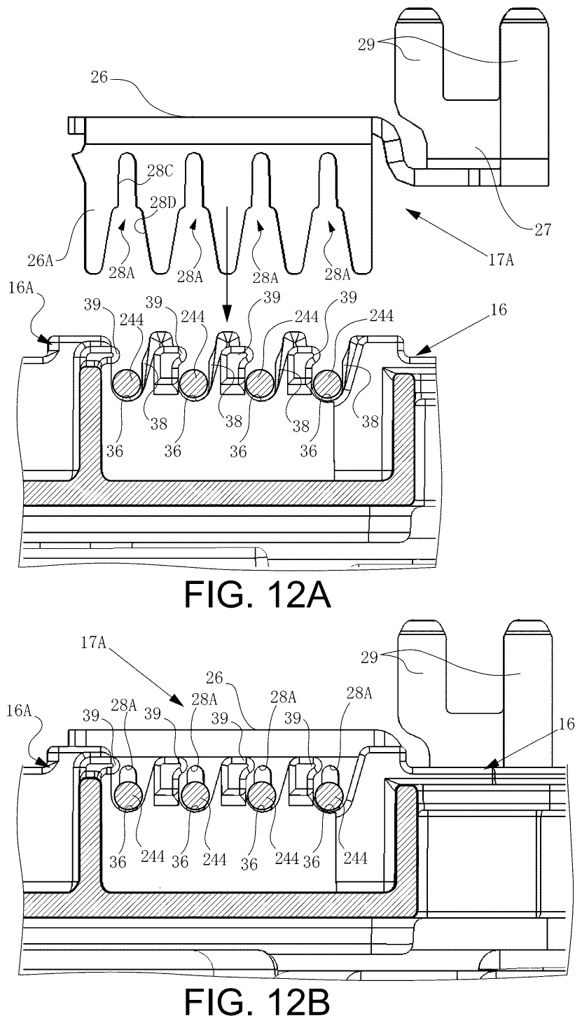

Multiple (in the present embodiment, four) lead parts 244 of the windings drawn out from the coil 243 are inserted into the accommodation groove 36 of the holding part 16A. The insertion of the lead parts 244 into the accommodation groove 36 is performed automatically by a machine such as a forming machine. FIG. 10A and FIG. 12A show a state during the insertion of the lead parts 244 into the accommodation groove 36.

Inside the accommodation groove 36, the rib 38 that reduces the dimension in the width direction X and the locking protrusion 39 protruding on the side opposite to the rib 38 are arranged. Thus, the lead part 244 comes into contact with the rib 38 and the locking protrusion 39. Accordingly, the lead part 244 is inserted into the accommodation groove 36 while bending into an S-shape due to elastic force.

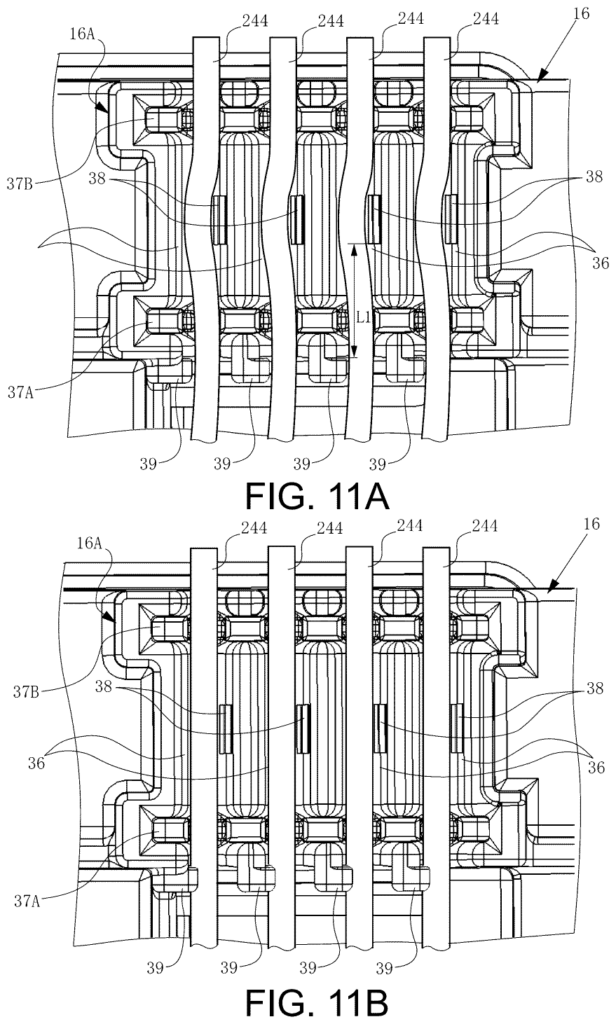

As shown in FIG. 10B and FIG. 11B, after the lead part 244 has climbed over the locking protrusion 39, the lead part 244 is restored in shape due to its elastic force. That is, the lead part 244 is in a linear shape and is accommodated inside the accommodation groove 36.

It is preferable to change a positional relationship between the rib 38 and the locking protrusion 39 according to rigidity of the lead part 244. In the case where the lead part 244 has high rigidity (low elastic force), the lead part 244 is less likely to bend into an S-shape. Accordingly, it is preferable that a distance L1 (see FIG. 11A) between the rib 38 and the locking protrusion 39 in the extension direction Z be appropriately changed according to the rigidity of the lead part 244. Accordingly, the lead part 244 becomes likely to bend into an S-shape.

After the lead part 244 has climbed over the locking protrusion 39, the lead part 244 is in a linear shape and is accommodated inside the accommodation groove 36. In the case where the lead part 244 is accommodated inside the accommodation groove 36, the locking protrusion 39 locks and restricts the lead part 244 from detaching from the accommodation groove 36.

As described above, by inserting the lead part 244 into the accommodation groove 36 with a small load, since the lead part 244 is temporarily held by the rib 38 and the locking protrusion 39, the lead part 244 can be temporarily held by simple work. In particular, when the lead part 244 climbs over the locking protrusion 39, the lead part 244 is deformed into an S-shape. This deformation is due to the elastic force of the lead part 244, and the lead part 244 can be inserted into the accommodation groove 36 with a small load.

As described above, in the width direction X, the interval D1 between the rib 38 and a side surface of the accommodation groove 36 facing the rib 38 as well as the interval D2 between the locking protrusion 39 and a side surface of the accommodation groove 36 facing the locking protrusion 39 are larger than the wire diameter R1 of the lead part 244. Hence, in the process for inserting the lead part 244 into the accommodation groove 36, less load is required than in the case of press-fitting the lead part, and the lead part 244 can be easily temporarily held by simply inserting the lead part 244 into the accommodation groove 36 with a small load and the same push-in amount.

As shown in FIG. 12A, after the lead part 244 is temporarily held in the accommodation groove 36, the lead part 244 is crimped into the slits 28A and 28B of the terminal 17A. As shown in FIG. 12B, while the lead part 244 is crimped into the slits 28A and 28B, the fitting pieces 26A and 26B are simultaneously fitted into the fitting grooves 37A and 37B. Accordingly, the terminal 17A and the lead part 244 can be held by the holding part 16A.

In the disclosure, unlike a conventional motor, the temporary holding of the lead part in the accommodation groove is not achieved by press-fitting. Furthermore, based on the above-described dimensional relationship between the wire diameter of the lead part 244 and the accommodation groove 36, rib 38, and locking protrusion 39, in the temporarily held state, the lead part 244 has a gap with respect to the accommodation groove 36. That is, the lead part 244 is movable in the width direction X within the accommodation groove 36. Hence, when crimping is performed in the slits 28A and 28B, the lead part 244 is able to follow the tapered part 28D of the slits 28A and 28B and smoothly enter the crimping part 28C.

When the lead part 244 is crimped into the slits 28A and 28B, coating on its surface is peeled off. Accordingly, the terminals 17A to 17C are electrically connected with the lead part 244. After the terminals 17A to 17C are connected with the lead part 244, the substrate 13 is fastened to the motor bracket 14 by the screw 25. Furthermore, the land 13B of the substrate 13 is soldered to the connecting piece 29 of the terminals 17A to 17C. Accordingly, the driver circuit 12 and the coil 243 are electrically connected via the terminals 17A to 17C.

As described above, in the process for inserting the lead part 244 into the accommodation groove 36, the lead part 244 can be easily temporarily held by simple insertion with a constantly small load and the same push-in amount. Thus, these processes can be automatically performed by a machine. That is, manual work by an operator becomes unnecessary, and work efficiency is improved.

In the disclosure, the temporary holding of the lead part 244 in the accommodation groove 36 is not achieved by press-fitting. That is, even if the process for inserting the lead part 244 into the accommodation groove 36 is performed, since the accommodation groove 36, rib 38, and locking protrusion 39 are not deformed, it will not be difficult to insert the lead part 244 into the accommodation groove 36 as in a conventional motor. Thus, in the motor 2 of the disclosure, multiple lead parts 244 can be simultaneously inserted into multiple accommodation grooves 36. Since the lead part 244 can be inserted into the accommodation groove 36 with a small load and the lead part 244 can be temporarily held by the rib 38 and the locking protrusion 39, the lead part 244 will not detach from the accommodation groove 36. That is, it is possible to stably maintain the lead part 244 in a temporarily held state, and the yield rate is improved.

The above-described embodiments are examples for describing the disclosure and are not intended to limit the scope of the disclosure to only those embodiments. Those skilled in the art can make appropriate modifications within the scope of the disclosure without departing from the spirit of the disclosure.

1. A motor, comprising:
a terminal, comprising a slit where a winding drawn out from a coil is crimped; and
a terminal holder, holding the terminal, wherein the terminal holder comprises:
an accommodation groove, formed between a first sidewall and a second sidewall arranged at predetermined intervals in a width direction orthogonal to an extension direction of the winding, and accommodating the winding;
a rib, provided on a portion of the first sidewall in the extension direction, and reducing a width dimension of the accommodation groove; and
a locking protrusion, provided on the second sidewall side at a position offset in the extension direction from the rib, and locking the winding accommodated in the accommodation groove.

2. The motor as claimed in claim 1, wherein,
in the width direction, an interval between the rib and the second sidewall is larger than a wire diameter of the winding.

3. The motor as claimed in claim 2, wherein,
in the width direction, an interval between the locking protrusion and the first sidewall is larger than the wire diameter of the winding.

4. The motor as claimed in claim 3, wherein,
in the width direction, an interval between a tip of the rib and a tip of the locking protrusion is smaller than the wire diameter of the winding.

5. The motor as claimed in claim 1, wherein,
in a depth direction of the accommodation groove that is orthogonal to the extension direction and the width direction, the rib is located closer to a bottom surface of the accommodation groove than the locking protrusion.

6. The motor as claimed in claim 1, wherein
the rib comprises an inclined surface that guides the winding accommodated in the accommodation groove toward the locking protrusion side.

7. The motor as claimed in claim 1, wherein
the terminal holder comprises a plurality of the accommodation grooves, and
the plurality of the accommodation grooves are arranged in parallel with respect to the width direction.
